(19) United States
(12) Patent Application Publication
(10) Pub. No.: US 2025/0008387 A1
(43) Pub. Date: Jan. 2, 2025

(54) ELECTRONIC APPARATUS, METHOD FOR CONTROLLING ELECTRONIC APPARATUS, AND STORAGE MEDIUM

(71) Applicant: CANON KABUSHIKI KAISHA, Tokyo (JP)

(72) Inventor: HIDEYUKI YOKKAICHI, Kanagawa (JP)

(21) Appl. No.: 18/755,392

(22) Filed: Jun. 26, 2024

(30) Foreign Application Priority Data
Jun. 30, 2023 (JP) 2023-107825

(51) Int. Cl. H04W 36/00

(52) U.S. Cl. CPC H04W 36/0066; H04W 36/0064

(57) ABSTRACT

An electronic apparatus includes at least one memory and at least one processor configured to receive a change request from a currently connected access point (AP) to change a connection destination AP to connect to; acquire, from a terminal device, connection information for connecting to a specific AP; perform a process of connecting to the specific AP in accordance with the connection information; perform control to execute a connection destination change based on the change request to change the connection destination AP in a first state in which a specific condition is satisfied after a connection is made to the specific AP; and perform control not to execute the connection destination change based on the change request in a second state in which the specific condition is not satisfied after a connection is made to the specific AP.

### BACKGROUND

### Field of the Disclosure

The present disclosure relates to an electronic apparatus capable of changing a connection destination access point (AP) to connect to in accordance with a connection destination change request from the AP, a method for controlling the electronic apparatus, and a storage medium.

### Description of the Related Art

A technique for an extended service set (ESS) including a plurality of APs involves dynamically switching a connection destination AP to which a station (STA) is to connect in the ESS to efficiently exchange data between the AP and the STA. When it is determined that the AP as the connection destination is to be switched on the basis of, for example, the congestion of the AP to which the STA is currently connected, the occupancy of the other APs, or radio wave conditions, the currently connected AP transmits an AP change request to the STA. Upon receiving the AP change request, the STA switches the connection destination AP in accordance with the request to connect to an appropriate AP.

Japanese Patent Laid-Open No. 2021-175068 discloses the following process for transmitting a request from a router having an AP function to a currently connected wireless slave unit to change a connection destination. A mobile router (MR1) connectable to a plurality of wireless slave units checks whether a wireless slave terminal supports Institute of Electrical and Electronics Engineers (IEEE) 802.11v. Whether the wireless slave terminal supports IEEE 802.11v can be determined from an Association Request frame transmitted from the wireless slave terminal to wirelessly connect to the MR1. If the wireless slave terminal supports IEEE 802.11v, a basic service set (BSS) transition management (BTM) Request frame is transmitted to the wireless slave terminal. In the BTM Request frame, a BSS Transition Candidate List Entries field specifies a basic service set identifier (BSSID) of a master router RT2 as the connection destination. Accordingly, switching of the connection destination of the slave terminal is prompted. In accordance with the received BTM Request frame, the wireless slave terminal switches the connection destination from the MR1 to the master router RT2.

Japanese Patent No. 6635978 proposes a method of transmitting connection information for connecting to an AP to which an information processing apparatus is connected to a communication device with which the information processing apparatus is communicating without the AP to connect the communication device to the AP.

As in Japanese Patent No. 6635978, in a case where connection information is transmitted from a terminal device to an electronic apparatus to set up a wireless local area network (LAN) for connecting the electronic apparatus to an AP, the setup for the wireless LAN is completed after the electronic apparatus connects to the AP and then performs some processes. The processes performed before the completion of the setup include, for example, communication confirmation for confirming the state of connection between the terminal device and the electronic apparatus via the AP and setting for transmitting a job from the information processing apparatus to the electronic apparatus. During the processes, if the AP to which the electronic apparatus is connected is changed in accordance with a connection destination change request from the AP as described in Japanese Patent Laid-Open No. 2021-175068, the setup may fail before completion.

### SUMMARY

Embodiments of the present disclosure provide a mechanism for reducing the possibility that the setup for a wireless LAN for connecting an electronic apparatus to an AP by transmitting connection information from a terminal device to the electronic apparatus fails due to a change of a connection destination AP.

To address the problem described above, an electronic apparatus according to an aspect of the present disclosure includes at least one memory and at least one processor that are configured to receive a change request from a currently connected access point (AP) to change a connection destination AP to connect to; acquire, from a terminal device, connection information for connecting to a specific AP; perform a process of connecting to the specific AP in accordance with the connection information; perform control to execute a connection destination change based on the change request to change the connection destination AP in a first state in which a specific condition is satisfied after a connection is made to the specific AP; and perform control not to execute the connection destination change based on the change request in a second state in which the specific condition is not satisfied after a connection is made to the specific AP.

Further features of various embodiments will become apparent from the following description of exemplary embodiments with reference to the attached drawings.

### BRIEF DESCRIPTION OF THE DRAWINGS

FIG. 1 is a diagram illustrating an example configuration of a system.

FIGS. 2A and 2B are diagrams illustrating an example configuration of a multifunction peripheral (MFP).

FIGS. 3A, 3B, and 3C are illustrations of example screens displayed on an operation display unit of the MFP.

FIGS. 4A and 4B are diagrams illustrating a configuration of a mobile terminal device.

FIG. 5 is a configuration diagram of an access point (AP).

FIG. 6 is a sequence diagram illustrating a process performed in response to a connection destination change request from the AP.

FIGS. 7A and 7B are a flowchart of a wireless LAN setup process executed by the MFP and a subsequent process for changing a connection destination in accordance with a connection destination change request according to a first embodiment.

FIG. 7C is a flowchart of a wireless LAN setup process executed by the mobile terminal device according to the first embodiment.

FIGS. 8A and 8B are a flowchart of a wireless LAN setup process executed by the MFP and a subsequent process for changing a connection destination in accordance with a connection destination change request according to a second embodiment.

FIG. 8C is a flowchart of a wireless LAN setup process executed by the mobile terminal device according to the second embodiment.

### DESCRIPTION OF THE EMBODIMENTS

An embodiment of the present disclosure will be described in detail hereinafter with reference to the drawings. It should be noted that the present embodiment is merely an example and specific examples of components, processing steps, display screens, and so on are not intended to limit the scope of the present disclosure unless otherwise specified.

### System Configuration

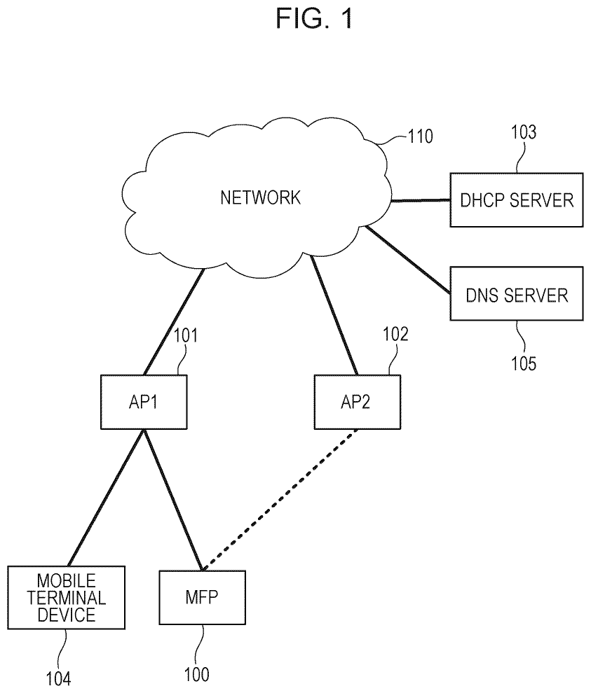

FIG. 1 illustrates an example configuration of a system according to the present embodiment. In one example, the system is a wireless communication system in which a plurality of communication devices can wirelessly communicate with each other. In the example illustrated in FIG. 1, the communication devices include a mobile terminal device 104, an MFP 100, access points AP1 (101) and AP2 (102), a dynamic host configuration protocol (DHCP) server 103, a domain name system (DNS) server 105, and a network 110. The mobile terminal device 104 is a device having a wireless communication function using a wireless local area network (LAN) or the like. The wireless LAN may be hereinafter referred to as a WLAN. The mobile terminal device 104 may be, for example, a personal information terminal such as a personal digital assistant (PDA), a mobile phone (smartphone), a digital camera, or a personal computer (PC).

The MFP 100 is a printer having a printing function. The MFP 100 may also have a reading function (scanner), a facsimile transmission (fax) function, and a telephone function. In the present embodiment, the MFP 100 also has a communication function for wirelessly communicating with the mobile terminal device 104. The present embodiment describes the MFP 100, by way of example but not limitation. Instead of the MFP 100, any other device having a communication function, such as a scanner device, a projector, a mobile terminal, a smartphone, a laptop PC, a tablet terminal, a PDA, a digital camera, a music playing device, a television, or a smart speaker, may be used. MFP is an acronym for Multi Function Peripheral.

The access point AP1 (101) is disposed separately from (or outside) the mobile terminal device 104 and the MFP 100, and operates as a WLAN base station device. A communication device having a WLAN communication function can perform communication in infrastructure mode for WLANs via the access point AP1 (101). In the following description, the access points may be referred to as “APs”. The infrastructure mode for WLANs may be referred to as “wireless infrastructure mode”. The access point AP1 (101) performs wireless communication with a communication device (authenticated communication device) allowed to connect to the access point AP1 (101), and relays wireless communication between the communication device and another communication device. The access point AP1 (101) may be connected to, for example, a wired communication network and may relay communication between a communication device connected to the wired communication network and another communication device wirelessly connected to the access point AP1 (101).

The access point AP2 (102) has a function equivalent to that of the access point AP1 (101). The MFP 100 switches the connection from the access point AP1 (101) to the access point AP2 (102), if necessary. The DHCP server 103 is connected to the MFP 100 via the access point AP1 (101) and the network 110, and responds to a request from the MFP 100 to provide a service to the MFP 100. In FIG. 1, the DHCP server 103 is connected as a device different from the access points AP1 (101) and AP2 (102). However, the access points AP1 (101) and AP2 (102) may have a DHCP server function. The DNS server 105 is connected to the MFP 100 and the mobile terminal device 104 via the access point AP1 (101) and the network 110, and responds to a request from the MFP 100 or the mobile terminal device 104 to provide a service for name resolution. The network 110 may be the Internet, a closed network within a company, or a mobile telephone network.

### Appearance of MFP

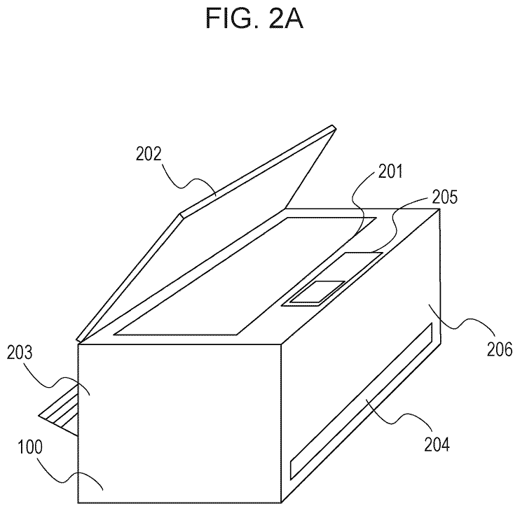

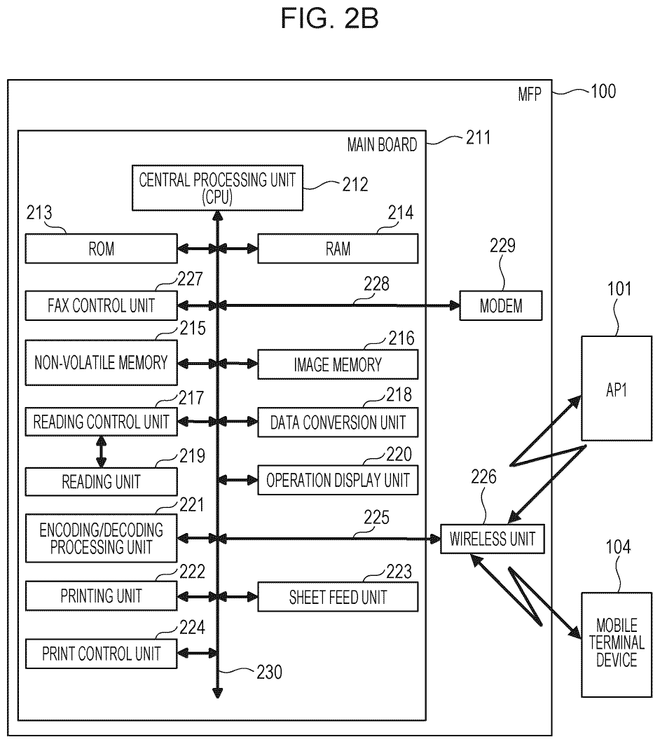

FIG. 2A illustrates an example appearance of the MFP 100. The MFP 100 includes, for example, a document table 201, a document cover 202, a print sheet insertion port 203, a print sheet discharge port 204, and an operation display unit 205. The document table 201 is a table on which a document to be read is placed. The document cover 202 is a cover to be closed to press a document placed on the document table 201 and prevent external leakage of light from a light source with which the document is irradiated during reading of the document. The print sheet insertion port 203 is an insertion port in which sheets of various sizes can be set. The print sheet discharge port 204 is a discharge port through which a printed sheet is discharged. The sheets set in the print sheet insertion port 203 are conveyed one by one to a printing unit 222 (described below), printed by the printing unit 222, and then discharged through the print sheet discharge port 204. The operation display unit 205 includes keys such as a character input key, a cursor key, an enter key, and a cancel key, a light-emitting diode (LED), a liquid crystal display (LCD), and so on. The operation display unit 205 is configured to accept operations performed by a user, such as the activation of various MFP functions and the setting of various settings.

The operation display unit 205 may further include a touch panel display. The MFP 100 has a wireless communication function using a WLAN, and includes a wireless communication antenna 206 for wireless communication. The wireless communication antenna 206 may be invisible from the outside. Like the mobile terminal device 104, the MFP 100 can also perform wireless communication using a WLAN in a frequency band such as the 2.4 GHz or 5 GHz band.

### Configuration of MFP

FIG. 2B illustrates an example configuration of the MFP 100. The MFP 100 includes a main board 211 for performing main control of the MFP 100, and a wireless unit 226. The wireless unit 226 is one communication module for performing WLAN communication by using at least one common antenna. The MFP 100 further includes a modem 229 for performing wired communication, for example. The main board 211 includes, for example, a central processing unit (CPU) 212, a read-only memory (ROM) 213, a random access memory (RAM) 214, a non-volatile memory 215, an image memory 216, a reading control unit 217, a data conversion unit 218, a reading unit 219, and an encoding/decoding processing unit 221. The main board 211 further includes, for example, the printing unit 222, a sheet feed unit 223, a print control unit 224, an operation display unit 220, and a fax control unit 227.

The functional units in the main board 211 described above are connected to each other via a system bus 230 managed by the CPU 212. The main board 211 and the wireless unit 226 are connected via, for example, a dedicated bus 225. The main board 211 and the modem 229 are connected via, for example, a bus 228.

The CPU 212 is a system control unit including at least one processor, and controls the overall operation of the MFP 100. In one example, the processes of the MFP 100, which will be described below, are implemented by the CPU 212 executing a program stored in the ROM 213. Hardware dedicated for each of the processes may be provided. The ROM 213 stores a control program executed by the CPU 212, an embedded operating system (OS) program, and so on. In the present embodiment, the CPU 212 executes each control program stored in the ROM 213 under the management of the embedded OS stored in the ROM 213 to control software, such as for scheduling and for switching tasks.

The RAM 214 includes a static random access memory (SRAM), for example. The RAM 214 stores data, such as data of program control variables, setting values registered by the user, and data for managing the MFP 100. The RAM 214 may also be used as a buffer for various works. The non-volatile memory 215 includes a memory, such as a flash memory, for example, and stores data continuously even after the power to the MFP 100 is turned off. The image memory 216 includes a memory, such as a dynamic random access memory (DRAM). The image memory 216 stores image data received via the wireless unit 226, image data processed by the encoding/decoding processing unit 221, and so on. The memory configuration of the MFP 100 is not limited to the configuration described above. The data conversion unit 218 performs processing such as analysis of data in various formats and conversion from image data to print data.

The reading control unit 217 controls the reading unit 219 (e.g., a contact image sensor (CIS)) to optically read a document placed on the document table 201. The reading control unit 217 converts an image obtained by optically reading the document into electrical image data (image signal) and outputs the electrical image data. At this time, the reading control unit 217 may perform various kinds of image processing, such as binarization and halftoning, before outputting the image data.

The operation display unit 220 corresponds to the operation display unit 205 described with reference to FIG. 2A, and executes processing such as displaying on the display under display control by the CPU 212 and generating a signal in response to acceptance of a user operation.

The encoding/decoding processing unit 221 performs encoding processing, decoding processing, and enlargement/reduction processing of image data (such as Joint Photographic Experts Group (JPEG) data or Portable Network Graphics (PNG) data) handled by the MFP 100.

The sheet feed unit 223 holds sheets for printing. The sheet feed unit 223 can feed a set sheet under the control of the print control unit 224. The sheet feed unit 223 may include a plurality of sheet feed units to hold a plurality of types of sheets in a single device, and control can be performed to determine from which of the sheet feed units to feed a sheet under the control of the print control unit 224.

The print control unit 224 performs various kinds of image processing, such as smoothing processing, print density correction processing, and color correction on image data to be printed, and outputs the processed image data to the printing unit 222. The printing unit 222 is configured to execute, for example, an inkjet printing process. The printing unit 222 ejects ink supplied from an ink tank through a print head and records an image on a recording medium such as a sheet of paper. The printing unit 222 may be configured to execute another printing process, such as an electrophotographic printing process. Further, the print control unit 224 may periodically read information on the printing unit 222 and update, for example, status information stored in the RAM 214. The status information includes, for example, the remaining amount of the ink tank, and the state of the print head.

The wireless unit 226 is a unit capable of providing a WLAN communication function. For example, the wireless unit 226 can provide a function similar to that of a combination with a WLAN unit 401 of the mobile terminal device 104. That is, in accordance with the WLAN standard, the wireless unit 226 converts data into packets and transmits the packets to another device, or restores packets from another external device into original data and outputs the original data to the CPU 212. The wireless unit 226 can perform communication as a station conforming to the series of IEEE 802.11 standards. In particular, the wireless unit 226 can perform communication as an IEEE 802.11a/b/g/n/ac/ax station. In the following description, a station may be referred to as an STA. In addition, the wireless unit 226 can perform communication as a Wi-Fi Agile Multiband™ STA.

The wireless unit 226 supports IEEE 802.11ax, or Wi-Fi6™, and can perform processes compliant with IEEE 802.11ax. That is, the MFP 100 can perform one or both of processing of an STA supporting (or compatible with) OFDMA and an operation (processing) of an STA supporting (or compatible with) TWT. OFDMA is short for Orthogonal Frequency Division Multiple Access. TWT is short for Target Wake Time. Since the wireless unit 226 supports TWT, the timing of data communication from the master device to the STA is adjusted. The wireless unit 226 (i.e., the MFP 100) serving as an STA puts the communication function into sleep state when there is no need to wait for signal reception. This configuration can reduce power consumption. The wireless unit 226 also supports Wi-Fi 6E™. That is, the wireless unit 226 can also perform communication over the 6 GHz band (5.925 GHz to 7.125 GHz). The 6 GHz band does not include a target band in which dynamic frequency selection (DFS) is implemented, which is included in the 5 GHz band. In the communication over the 6 GHz band, accordingly, communication disconnection caused by the DFS waiting time does not occur. As a result, it can be expected to perform more comfortable communication.

The mobile terminal device 104 and the MFP 100 can perform peer-to-peer (P2P) (WLAN) communication based on Wi-Fi Direct (WFD), and the wireless unit 226 has a software access point (Soft-AP) function or a group owner function. That is, the wireless unit 226 can establish a P2P communication network and determine a channel to be used for P2P communication.

### Operation Display Unit of MFP

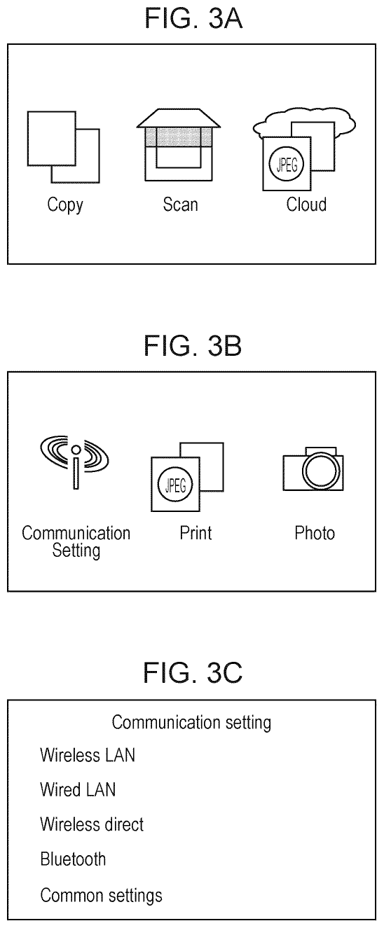

FIGS. 3A to 3C schematically illustrate example screens displayed on the display (touch panel display) included in the operation display unit 220 of the MFP 100. FIG. 3A illustrates an example of a home screen displayed when operation, such as printing or scanning, does not take place after power to the MFP 100 is turned on (when the MFP 100 is in idle state or standby state). In FIG. 3A, display items (menu items) marked “Copy”, “Scan”, and “Cloud” are displayed. The item “cloud” is a menu item related to a cloud function using Internet communication. When one of the menu items is selected by a key operation or a touch panel operation, the MFP 100 can start implementing a corresponding setting or function. The MFP 100 accepts a key operation or a touch panel operation on the home screen illustrated in FIG. 3A to seamlessly display a screen different from that illustrated in FIG. 3A.

FIG. 3B illustrates a display example of another portion of the home screen. In response to an operation of displaying another page of the home screen (such as sliding from left to right or vice versa), a transition occurs from the state illustrated in FIG. 3A to a screen illustrated in FIG. 3B. In FIG. 3B, display items (menu items) marked “Communication setting”, “Print”, and “Photo” are displayed. When one of these menu items is selected, a function corresponding to the selected menu item, that is, one of a print function, a photo function, and communication setting, is implemented.

FIG. 3C illustrates a display example of a menu screen for communication setting, which is displayed when the communication setting is selected on the screen illustrated in FIG. 3B. The menu screen for communication setting displays menu items (options) “Wireless LAN”, “Wired LAN”, “Wireless direct”, “Bluetooth”, and “Common settings”. The items “Wireless LAN”, “Wired LAN”, and “Wireless direct” are menu items for performing LAN setting, and one of these items is used to perform setting, such as setting a wired connection, enabling or disabling the wireless infrastructure mode, or enabling or disabling the P2P mode such as WFD or Soft-AP mode. When the item “Wireless LAN” is selected and the wireless LAN is set to be enabled by a user operation, the wireless infrastructure mode is enabled. When the item “Wireless direct” is selected and wireless direct is set to be enabled by a user operation, the P2P (WLAN) mode is enabled. This screen also displays a “Common settings” menu related to each connection mode. On this screen, the user can further set the frequency band and the frequency channel for the wireless LAN.

### Appearance of Mobile Terminal Device

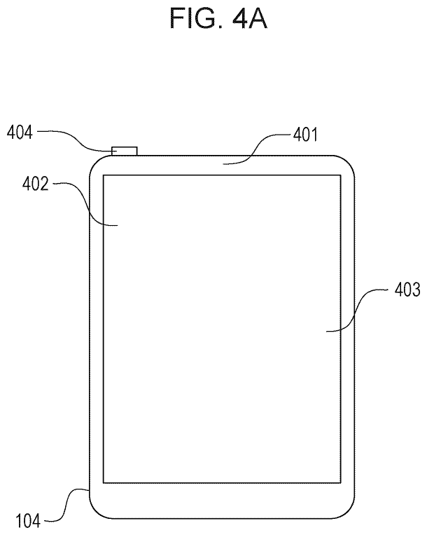

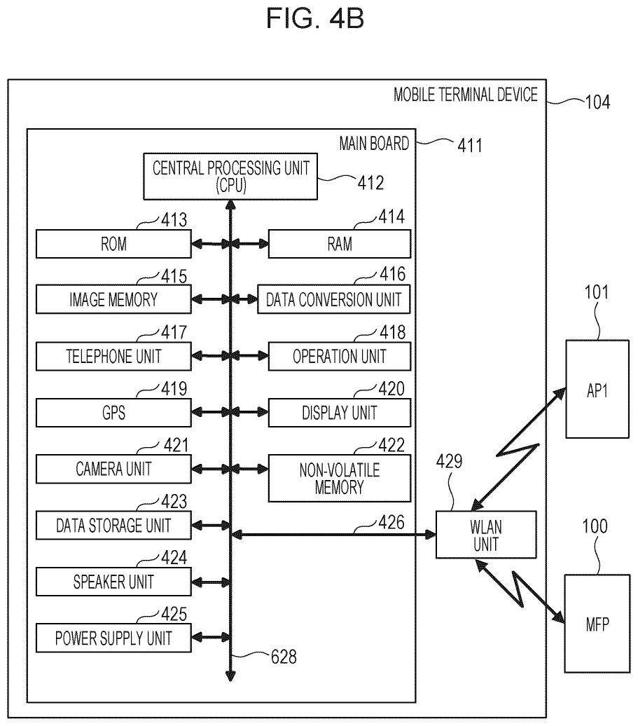

FIG. 4A is a diagram illustrating an example appearance of the mobile terminal device 104. In the present embodiment, as an example, the mobile terminal device 104 is a typical smartphone. The mobile terminal device 104 includes, for example, a display unit 402, an operation unit 403, and a power key 404. The display unit 402 is, for example, a display including an LCD display mechanism. The display unit 402 may display information by using, for example, an LED. The mobile terminal device 104 may have a function of outputting information by voice in addition to or instead of the display unit 402. The operation unit 403 includes hard keys, such as keys and buttons, a touch panel, and so on, to detect a user operation.

In the illustrated example, a common touch panel display is used to display information on the display unit 402 and accept a user operation by the operation unit 403. Thus, the display unit 402 and the operation unit 403 are implemented by a single device. In this case, for example, a button icon or a software keyboard is displayed using a display function of the display unit 402, and a touch by the user on the button icon or the software keyboard is detected by an operation accepting function of the operation unit 403. The display unit 402 and the operation unit 403 may be separate from each other, and hardware for display and hardware for operation acceptance may be separately provided. The power key 404 is a hard key for accepting a user operation for turning on or off the power to the mobile terminal device 104.

The mobile terminal device 104 includes a WLAN unit 401 that provides a WLAN communication function. The WLAN unit 401 may be invisible from the outside. The WLAN unit 401 is configured to execute data (packet) communication in a WLAN system conforming to, for example, the series of IEEE 802.11 standards (such as IEEE 802.11a/b/g/n/ac/ax).

In addition, the WLAN unit 401 can perform communication as a Wi-Fi Agile Multiband™ AP. However, the present disclosure is not limited to this configuration, and the WLAN unit 401 may be configured to execute communication in a WLAN system conforming to any other standard. In the illustrated example, it is assumed that the WLAN unit 401 can perform communication over both the 2.4 GHz and 5 GHz bands. It is also assumed that the WLAN unit 401 can execute communication based on WFD, communication in the Soft-AP mode, communication in the wireless infrastructure mode, and so on. Operations in these modes will be described below.

### Configuration of Mobile Terminal Device

FIG. 4B illustrates an example configuration of the mobile terminal device 104. In one example, the mobile terminal device 104 includes a main board 411 for performing main control of the mobile terminal device 104, and a WLAN unit 429 that performs WLAN communication. The main board 411 includes, for example, a CPU 412, a ROM 413, a RAM 414, an image memory 415, a data conversion unit 416, a telephone unit 417, a GPS 419, a camera unit 421, a non-volatile memory 422, a data storage unit 423, a speaker unit 424, and a power supply unit 425. CPU is an acronym for Central Processing Unit, ROM is an acronym for Read Only Memory, RAM is an acronym for Random Access Memory, and GPS is an acronym for Global Positioning System. The mobile terminal device 104 further includes a display unit 420 and an operation unit 418. The functional units in the main board 411 described above are connected to each other via a system bus 628 managed by the CPU 412. The main board 411 and the WLAN unit 429 (the WLAN unit 401 described above) are connected to each other via, for example, a dedicated bus 426.

The CPU 412 is a system control unit including at least one processor, and controls the overall operation of the mobile terminal device 104. In one example, the processes of the mobile terminal device 104, which will be described below, are implemented by the CPU 412 executing a program stored in the ROM 413. Hardware dedicated for each of the processes may be provided. The ROM 413 stores a control program executed by the CPU 412, an embedded OS program, and so on. In the present embodiment, the CPU 412 executes each control program stored in the ROM 413 under the management of the embedded OS stored in the ROM 413 to control software such as for scheduling and for switching tasks.

The RAM 414 includes an SRAM, for example. The RAM 414 stores data such as data of program control variables, setting values registered by the user, and data for managing the mobile terminal device 104. The RAM 414 may also be used as a buffer for various works. The image memory 415 includes a memory, such as a DRAM. The image memory 415 temporarily stores image data received via the WLAN unit 429 and image data read from the data storage unit 423 such that the CPU 412 processes the image data. The non-volatile memory 422 includes a memory, such as a flash memory, for example, and stores data continuously even after the power to the mobile terminal device 104 is turned off. The memory configuration of the mobile terminal device 104 is not limited to the configuration described above. For example, the image memory 415 and the RAM 414 may be shared, or the data storage unit 423 may be used to back up data, for example. In the present embodiment, one example of the image memory 415 is a DRAM. However, any other storage medium such as a hard disk or a non-volatile memory may be used as the image memory 415.

The data conversion unit 416 performs analysis of data in various formats and data conversion such as color conversion and image conversion. The telephone unit 417 controls a telephone line and processes audio data input or output via the speaker unit 424 to implement telephone communication. The GPS 419 receives radio waves transmitted from satellites and acquires the position information such as the latitude and longitude of the current position of the mobile terminal device 104.

The camera unit 421 has a function of electronically recording and encoding an image input via a lens. The image data of an image captured by the camera unit 421 is stored in the data storage unit 423. The speaker unit 424 performs control to implement a function of inputting or outputting a voice for the telephone function or implement other functions, such as an alarm notification. The power supply unit 425 is, for example, a portable battery and controls power supply to the mobile terminal device 104. The states of power supply include, for example, a depleted battery state in which the battery has no remaining capacity, a power-off state in which the power key 404 remains unpressed, an activated state in which the mobile terminal device 104 is normally activated, and a power-saving state in which the mobile terminal device 104 is activated and is in power saving mode.

The display unit 420 corresponds to the display unit 402 described with reference to FIG. 4A, and accepts various input operations and displays the operating state and status of the MFP 100, for example, under the control of the CPU 412. The operation unit 418 corresponds to the operation unit 403 described with reference to FIG. 4A. In response to a user operation, the operation unit 418 performs control to, for example, generate an electrical signal corresponding to the operation and output the electrical signal to the CPU 412.

In the mobile terminal device 104, the WLAN unit 429 is used to perform wireless communication and perform data communication with other devices, such as the MFP 100. The WLAN unit 429 converts data into packets and transmits the packets to another device. Further, the WLAN unit 429 restores packets from another external device into original data and outputs the original data to the CPU 412. The WLAN unit 429 is a unit for implementing communication compliant with each WLAN standard. The WLAN unit 429 can operate concurrently in at least two communication modes including the wireless infrastructure mode and the P2P (WLAN) mode. The frequency bands used in these communication modes may be limited by hardware functions and capabilities.

### Configuration of Access Point

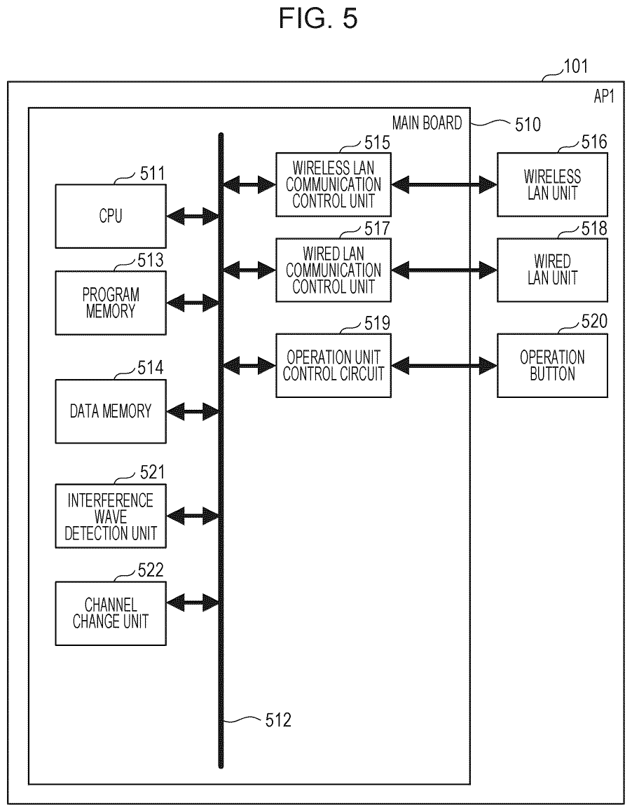

FIG. 5 is a block diagram illustrating the configuration of the access point AP1 (101) having a wireless LAN access point function. The access point AP1 (101) includes a main board 510 for controlling the access point AP1 (101), a wireless LAN unit 516, a wired LAN unit 518, and an operation button 520.

A CPU 511 is in the form of a microprocessor disposed on the main board 510 and operates in accordance with a control program stored in a program memory 513 in ROM form and the content of a data memory 514 in RAM form. The program memory 513 and the data memory 514 are connected to the CPU 511 via an internal bus 512. The CPU 511 controls the wireless LAN unit 516 through a wireless LAN communication control unit 515 to perform wireless LAN communication with other communication terminal devices. Further, the CPU 511 controls the wired LAN unit 518 through a wired LAN communication control unit 517 to perform wired LAN communication with other communication terminal devices. The CPU 511 can control an operation unit control circuit 519 to accept an operation from the user using the operation button 520. The CPU 511 includes at least one processor.

The access point AP1 (101) further includes an interference wave detection unit 521 and a channel change unit 522.

The interference wave detection unit 521 performs a process of detecting an interference wave during wireless communication performed over a band in which DFS is implemented. In response to detection of an interference wave during wireless communication performed over a band in which DFS is implemented, the channel change unit 522 performs a process of changing a channel to be used when, for example, the channel immediately needs to be changed to an available channel.

The access point AP2 (102) has a configuration similar to that of the access point AP1 (101).

### P2P Communication Method

Next, a brief description will be given of a P2P (WLAN) communication method for allowing devices to wirelessly communicate directly with each other without using an external access point in WLAN communication. P2P (WLAN) communication can be implemented by using a plurality of methods. For example, a communication device supports a plurality of modes for P2P (WLAN) communication and selectively uses one of the plurality of modes to execute P2P (WLAN) communication.

The following two P2P modes are provided:
Soft-AP mode; and
WFD mode.

A communication device capable of executing P2P communication may be configured to support at least one of these modes. However, even a communication device capable of executing P2P communication need not support all of these modes, and may be configured to support only parts of these modes.

A communication device (e.g., the mobile terminal device 104) having a WFD communication function calls an application (or a dedicated application, if any) for implementing the communication function in response to a user operation accepted via an operation unit of the communication device. Then, the communication device displays a screen of a user interface (UI) provided by the application to prompt the user to perform an operation, and can execute WFD communication in response to the acceptance of the operation performed by the user.

### Soft-AP Mode

In the Soft-AP mode, a communication device (e.g., the mobile terminal device 104) operates in the role of a client that requests various services. Then, the other communication device (e.g., the MFP 100) operates as a Soft-AP that is set by software to implement the function of an AP in the WLAN. Since commands and parameters transmitted and received in a wireless connection established between the client and the Soft-AP are commands and parameters defined by the Wi-Fi® standard, a description thereof will be omitted. The MFP 100 operating in the Soft-AP mode operates as a master station and determines a frequency band and a frequency channel. Accordingly, the MFP 100 can select which frequency band to use from among the 5 GHz and 2.4 GHz bands and which frequency channel to use in that frequency band.

### WFD Mode

The MFP 100 may be activated as a fixed master station in the WFD mode (i.e., an autonomous group owner). In this case, a group owner (GO) negotiation process for determining the roles is not performed. In this case, furthermore, the MFP 100 operates as a master station and determines a frequency band and a frequency channel. Accordingly, the MFP 100 can select which frequency band to use from among the 5 GHz and 2.4 GHz bands and which frequency channel to use in that frequency band.

### Wireless Infrastructure Mode

In the wireless infrastructure mode, communication devices (e.g., the mobile terminal device 104 and the MFP 100) that communicate with each other are connected to an external AP (e.g., the access point AP1 (101)) that controls the network, and the communication between the communication devices is performed via the external AP. In other words, communication is performed between the communication devices via a network established by the external AP. The mobile terminal device 104 and the MFP 100 individually discover the access point AP1 (101), transmit a connection request to the access point AP1 (101), and connect to the access point AP1 (101). As a result, these communication devices can communicate with each other in the wireless infrastructure mode via the access point AP1 (101). A plurality of communication devices may connect to different APs. In this case, data transfer is performed between the APs to allow communication between the communication devices. Since commands and parameters transmitted and received during communication between the communication devices via an access point or access points are commands and parameters defined by the Wi-Fi® standard, a description thereof will be omitted. In this case, the access point AP1 (101) determines a frequency band and a frequency channel. Accordingly, the access point AP1 (101) can select which frequency band to use from among the 5 GHz, 2.4 GHz, and 6 GHz bands and which frequency channel to use in that frequency band.

Process in Response to Connection Destination Change Request from AP to STA

The mobile terminal device 104 and the MFP 100 support a feature publicly available as Wi-Fi Agile Multiband™. The Wi-Fi Agile Multiband feature enables selection of an optimal environment in accordance with the changing situation of a Wi-Fi network. Specifically, a STA, such as the mobile terminal device 104 and the MFP 100, and an AP, such as the access point AP1 (101), exchange information on the network environment by using the series of IEEE 802.11 communication standards. The exchange of such information allows the AP to guide the STA to another AP, frequency band, or channel, or even to another cellular service in some cases (change the connection destination) when the network is congested.

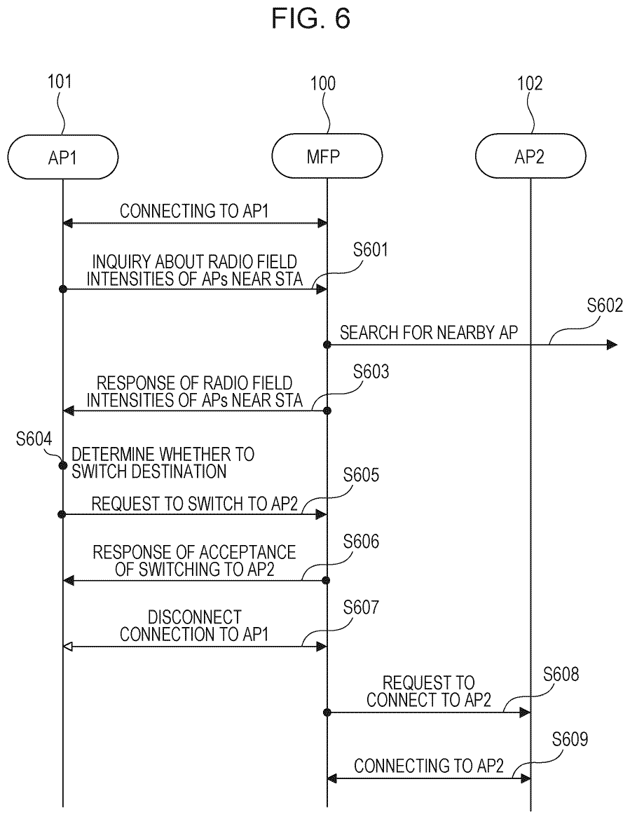

FIG. 6 is a sequence diagram of a process in which the MFP 100 switches a connection destination AP to connect to from the access point AP1 (101) to the access point AP2 (102) in accordance with a connection destination change request from the access point AP1 (101).

The processing executed by each device in the illustrated sequence is implemented by a CPU included in the device reading various programs stored in a memory such as a ROM included in the device into a RAM included in the device and executing the programs.

In the process illustrated in FIG. 6, in the initial state, the MFP 100 has established a connection with the access point AP1 (101) in the wireless infrastructure mode. When the MFP 100 and the access point AP1 (101) are connected to each other in the wireless infrastructure mode, the access point AP1 (101) has acquired information indicating whether the MFP 100 supports IEEE 802.11v. The following process is performed if information indicating that the MFP 100 supports IEEE 802.11v has been acquired by the access point AP1 (101).

In S601, the access point AP1 (101) transmits, to the MFP 100, an inquiry (measurement requests) about the radio field intensities of APs located near the MFP 100. The inquiry is transmitted as, for example, a beacon frame request or a beacon report request. That is, a request defined by the IEEE 802.11k standard can be used.

In S602, in response to the request received in S601, the MFP 100 receives frames transmitted from the APs located near the MFP 100 and measures the respective radio field intensities of the APs. As a result, the radio field intensity of each of a plurality of APs including the access points AP1 (101) and AP2 (102) is measured.

In S603, the MFP 100 transmits a list of radio field intensities of the APs located near the MFP 100, which are measured in S602, as a response to the request received in S601. The radio field intensities to be transmitted as the response may be, in addition to or instead of the information measured in S602, information stored in, for example, the RAM 214 and the non-volatile memory 215 of the MFP 100. The response is transmitted as, for example, Beacon Report or measurement reports.

In S604, the access point AP1 (101) determines whether to switch the connection destination of the MFP 100, on the basis of the network congestion recognized by the access point AP1 (101) and the radio field intensities received from the MFP 100 in S603. Examples of the factors for the access point AP1 (101) to determine to change the connection destination include a large number of STAs connected, a large amount of communication, reduced congestion in a network for another AP, the presence or absence of interfering radio waves, and a stoppage of the AP function. If the access point AP1 (101) determines to switch the connection destination of the MFP 100 and determines the service set identifier (SSID) of another AP to be designated as a destination to which the MFP 100 is to be connected, a channel, and a frequency band, the process proceeds to S605.

In S605, the access point AP1 (101) transmits an AP change request (connection destination change request) to the MFP 100. The connection destination change request includes information on the SSID of the other AP designated as the destination to which the MFP 100 is to be connected, the channel, and the frequency band, which are determined in S604.

A plurality of SSIDs may be designated. The connection destination change request is transmitted as, for example, a basic service set (BSS) transition management (BTM) Request. That is, a BTM Request frame defined by the IEEE 802.11v standard is transmitted. In the example illustrated in FIG. 6, the access point AP2 (102) is designated as the destination included in the connection destination change request.

In S606, if the MFP 100 follows the connection destination change request received in S605, the MFP 100 transmits to the access point AP1 (101) a response indicating acceptance of the switching of the connection destination. If the MFP 100 does not follow the connection destination change request, the MFP 100 may transmit a response indicating rejection of the switching of the connection destination. The response is transmitted as a BTM Response. In the example illustrated in FIG. 6, it is assumed that a response indicating acceptance of the switching of the connection destination is transmitted.

In S607, the access point AP1 (101) and the MFP 100 disconnect the connection in the wireless infrastructure mode.

In S608, the MFP 100 transmits a connection request to the access point AP2 (102) so as to connect to the access point AP2 (102) designated by the connection destination change request received in S605.

As a result, in S609, a connection between the MFP 100 and the access point AP2 (102) in the wireless infrastructure mode is established.

This mechanism allows the MFP 100 serving as an STA to change the connection destination from the access point AP1 (101) to the access point AP2 (102) in accordance with a connection destination change request from the access point AP1 (101) to which the MFP 100 is originally connected. The access points AP1 (101) and AP2 (102) may be located in different locations. That is, through the process illustrated in FIG. 6, the MFP 100 can switch the connection destination from an AP to which the MFP 100 is originally connected to another AP installed at a different position. The access points AP1 (101) and AP2 (102) may support different frequency bands among a plurality of frequency bands (two or three of the 2.4 GHz, 5 GHz, and 6 GHz bands) provided by the same device. That is, through the process illustrated in FIG. 6, the MFP 100 can switch the frequency band to another frequency band provided by the same device as the AP to which the MFP 100 is originally connected. For example, the MFP 100 can change the connection destination to an AP in the 6 GHz band in response to a connection destination change request.

The present embodiment describes an example in which a measurement request and a connection destination change request are transmitted from an AP by using a mechanism compliant with Wi-Fi Agile Multiband™ and an STA responds to these requests. However, some embodiments of the present disclosure are not limited to this example. Some embodiments are also applicable when an STA responds and changes a connection destination AP (switching, deletion, or addition of an AP serving as a connection destination) in response to a measurement request and a connection destination change request transmitted from an AP by using a mechanism different from that in the example described above.

### First Embodiment

In response to acceptance of a predetermined operation on the operation display unit 220, the MFP 100 is set to a wireless LAN setup mode in which the setting of a wireless LAN (reception of connection information) can be accepted from the mobile terminal device 104 via P2P connection. A setting of a wireless LAN (communication setting) via P2P connection is hereinafter referred to as a wireless LAN setup, and a mode in which connection information is received and a connection to an AP can be attempted is hereinafter referred to as a wireless LAN setup mode. The connection information includes an SSID, which is identification information of the AP, and passwords (a network key, a wired equivalent privacy (WEP) key, and a passphrase). The setting to the wireless LAN setup mode is triggered by, for example, detection of an initial setting flag when the power is turned on for the first time after the purchase of the MFP 100, or acceptance of an instruction from the user to operate in the wireless LAN setup mode. Alternatively, the setting to the wireless LAN setup mode may be triggered by acceptance of a predetermined command by a beacon or the like. Examples of the setting of a wireless LAN include setting of an access point to which the MFP 100 is connected, setting of a Transmission Control Protocol/Internet Protocol (TCP/IP) address, and security setting.

In the present embodiment, the description will be given on the assumption that the mobile terminal device 104 performs the LAN setting of the MFP 100 by the wireless LAN setup to establish an infrastructure connection with the MFP 100. Specifically, the mobile terminal device 104 sets an AP (e.g., the access point AP1 (101)) to which the mobile terminal device 104 is originally connected as a connection destination of the MFP 100, and can accordingly establish an infrastructure connection with the MFP 100 via the AP (the access point AP1 (101)).

In the wireless LAN setup, the mobile terminal device 104 transmits connection information used to connect to the AP to the MFP 100 in the P2P mode. Subsequently, the MFP 100 connects to the AP in accordance with the received connection information, and the mobile terminal device 104 also connects to the same AP. As a result, an infrastructure connection can be established.

In the wireless LAN setup mode, the function of a software AP provided in the MFP 100 is enabled to allow an access point function in the MFP 100 to operate. The access point function in the MFP 100 may be to allow connection without authentication or encryption processing using a password, for example. Also, the access point function in the MFP 100 may be to allow connection by fixed connection information (here, connection information for connecting to an access point in the MFP 100) incorporated in advance in a setting application installed in the mobile terminal device 104, which executes the wireless LAN setup. The MFP 100 is configured to be capable of receiving and interpreting a command from the setting application, and changes the LAN setting of the MFP 100 in accordance with the received command.

This allows the mobile terminal device 104 to connect to the MFP 100 operating in the wireless LAN setup mode without accepting an input of connection information for connecting to the MFP 100 from the user or acquiring the connection information from the MFP 100.

Further, with the setting application, the mobile terminal device 104 performs communication confirmation to confirm that the STA is connected to the AP designated by the connection information by using the wireless LAN setup. Specifically, for example, a simple network management protocol (SNMP) is used for communication confirmation. However, the protocol for communication confirmation is not limited to the SNMP, and any other protocol may be used.

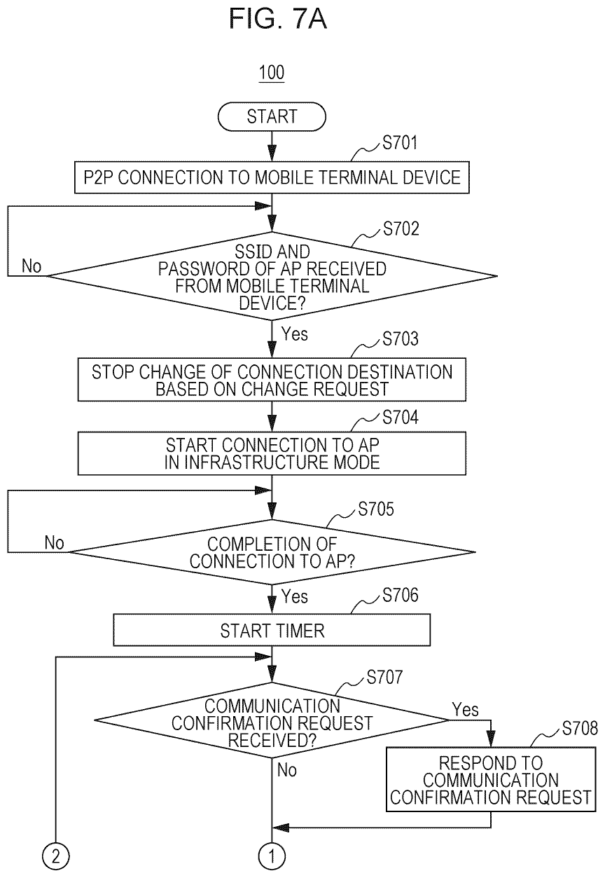

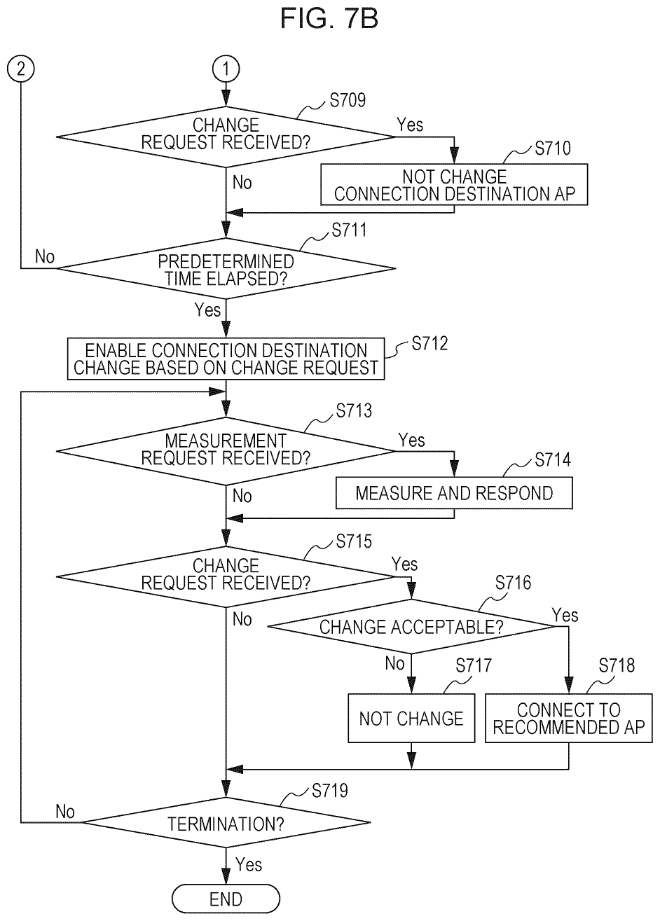

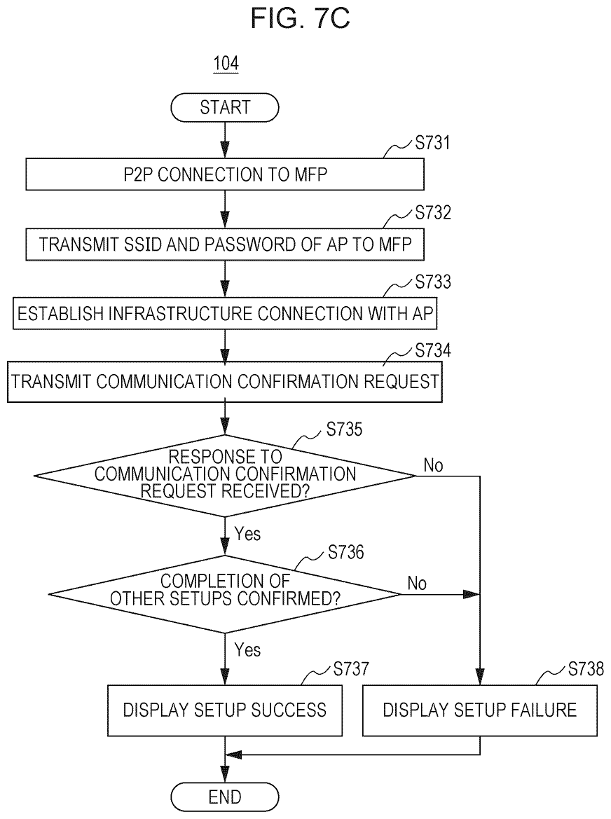

FIGS. 7A and 7B are a flowchart of a wireless LAN setup process executed by the MFP 100 and a subsequent process for changing a connection destination in accordance with a connection destination change request. The illustrated process is implemented by the CPU 212 reading a program stored in the ROM 213 into the RAM 214 and executing the program.

FIG. 7C is a flowchart of a wireless LAN setup process executed by the mobile terminal device 104. FIG. 7C illustrates a process linked to the process illustrated in FIGS. 7A and 7B, which is executed by the MFP 100. The illustrated process is implemented by the CPU 412 reading a program stored in the ROM 413 into the RAM 414 and executing the program. The illustrated process is implemented by execution of an application or an OS installed in the mobile terminal device 104.

The process illustrated in FIGS. 7A and 7B will be described. When the MFP 100 is set to the wireless LAN setup mode, the process illustrated in FIGS. 7A and 7B is started.

In S701, the CPU 212 establishes a connection with the mobile terminal device 104 in the P2P mode.

In S702, the CPU 212 determines whether the connection information (such as the SSID and the password) of the AP is received from the mobile terminal device 104. If the connection information is received, the process proceeds to S703; otherwise, the process waits for the connection information to be received.

In S703, the CPU 212 sets a suppression state for stopping (or suppressing) the change of the connection destination AP based on the connection destination change request from the AP, and records, in the RAM 214, information indicating that the suppression state is set. In the suppression state, the change of the connection destination AP based on the connection destination change request from the AP is suppressed by, for example, any one or a combination of two or more of the following methods.

### First Method

In response to receipt of a connection destination change request from a currently connected AP, the CPU 212 transmits information indicating ignoring or rejection to the AP and performs control to maintain the connection with the currently connected AP without changing the connection destination in accordance with the received connection destination change request.

### Second Method

In response to receipt of a measurement request, the CPU 212 performs control to make a response (false response) by transmitting information indicating that the radio wave reception status of an AP other than the currently connected AP is worse than the status actually measured (e.g., a weak radio wave, much noise, or an undetectable radio wave). This makes it expectable to suppress transmission of a request from the currently connected AP to change the connection destination to another AP. Accordingly, a change of the connection destination according to a connection destination change request is suppressed.

### Third Method

When connecting to the AP, the CPU 212 transmits information indicating that the MFP 100 does not support the function of changing the connection destination AP in accordance with a connection destination change request to the AP, and connects to the AP. Specifically, for example, before wirelessly connecting to the AP, the CPU 212 creates data of an Association Request frame including information indicating that the MFP 100 does not support IEEE 802.11v. Then, the CPU 212 performs an operation including transmitting the created data of the Association Request frame to perform a process of wirelessly connecting to the AP. The information indicating that the MFP 100 does not support IEEE 802.11v is, more specifically, information indicating that, for example, a flag of BSS Transition Support for Association Request is turned off. As a result, the connection destination AP recognizes that the MFP 100 does not support the connection destination change function (disabled), and a measurement request or a connection destination change request is not transmitted from the currently connected AP to the MFP 100. Accordingly, a change of the connection destination according to a connection destination change request is suppressed. In a case where the third method is used, when connecting to the AP in the subsequent control of S704, the CPU 212 transmits information indicating that the MFP 100 does not support the function of changing the connection destination AP in accordance with a connection destination change request to the AP, and connects to the AP.

In S704, the CPU 212 disconnects the P2P connection with the mobile terminal device 104 and starts connection with the AP indicated by the connection information in the wireless infrastructure mode on the basis of the connection information (such as the SSID and the password) received from the mobile terminal device 104 in S702. In the present embodiment, a description will be given on the assumption that the connection to the access point AP1 (101) is made.

In S705, the CPU 212 determines whether the connection with the access point AP1 (101) in the wireless infrastructure mode has been completed. If it is determined that the connection has been completed, the process proceeds to S706; otherwise (if the connection has not been completed), the process waits in S705 for the connection to be completed.

In S706, the CPU 212 starts a timer for measuring a predetermined time. The timer is used to measure a predetermined time for not responding to the connection destination change request because it is not known when the MFP 100 can receive the communication confirmation from the mobile terminal device 104. The timer is not necessarily started immediately after the connection between the MFP 100 and the access point is completed. The timer may be started before the connection is completed. In the present embodiment, the predetermined time is about 10 to 30 seconds.

In S707, the CPU 212 determines whether a communication confirmation request is received from the mobile terminal device 104. If it is determined that a communication confirmation request is received, the process proceeds to S708; otherwise, the process proceeds to S709. For example, the mobile terminal device 104 transmits, as a communication confirmation request, a reference request (GetRequest-PDU) to the access point AP1 (101) by broadcast by using SNMP. The access point AP1 (101) transmits a reference request to the connected STA. Upon receiving the reference request transmitted from the access point AP1 (101), the MFP 100 transmits response data capable of identifying the MAC address thereof as a response (Response-PDU). The mobile terminal device 104 compares the MAC address of the MFP 100, which is stored in advance, with the MAC address of the received response data. If the MAC addresses match, the mobile terminal device 104 determines that the response data has been transmitted from the MFP 100. As a result, communication between the MFP 100 and the access point AP1 (101) is established, and it can be confirmed that the mobile terminal device 104 and the MFP 100 are allowed to communicate with each other via the access point AP1 (101). That is, communication can be confirmed. The response data to be referred to is not limited to the MAC address as long as the STA can uniquely identify the response data. The determination of S707 is whether the reference request transmitted from the access point AP1 (101) is received.

In S708, the CPU 212 responds to the communication confirmation request. That is, the CPU 212 transmits, as a response (Response-PDU) to the received reference request, response data capable of identifying the MAC address of the MFP 100 to the mobile terminal device 104.

In S709, the CPU 212 determines whether a connection destination change request (described above in S605) is received from the currently connected AP. If a connection destination change request is received, the process proceed to S710; otherwise, the process proceed to S711. In a case where the connection destination change based on the connection destination change request has been suppressed by using the second or third method described above, the processing of S709 may be omitted because the change request itself is not likely to be transmitted. In a case where the connection destination change based on the connection destination change request has been suppressed by using the first or second method described above, a measurement request may be received in this situation, but the description of the process therefor will be omitted.

In S710, the CPU 212 responds to and rejects the connection destination change request received in S709 or ignores the connection destination change request without responding. Then, the CPU 212 performs control not to perform the change of the connection destination AP based on the connection destination change request.

In S711, the CPU 212 determines, based on the timer started in S706, whether the predetermined time has elapsed. If the predetermined time has elapsed (if a condition that the predetermined time has elapsed since the completion of connection to the AP is satisfied as a specific condition), the process proceeds to S712; otherwise, the process returns to S707 to repeat the processing.

In S712, the CPU 212 performs a process of enabling the connection destination change based on the connection destination change request. This processing is to cancel the suppression state set in S703, and clears the information indicating the suppression state recorded in the RAM 214. In a case where the control for setting the suppression state has been performed using the third method described above, the CPU 212 disconnects the connection to the currently connected AP and then reconnects to the same AP.

At this time, the CPU 212 transmits information indicating that the MFP 100 supports the function of changing the connection destination AP in accordance with a connection destination change request to the AP.

In S713, the CPU 212 determines whether a measurement request (the measurement requests described above in S601 in FIG. 6) is received from the currently connected AP. If a measurement request is received, the process proceed to S714; otherwise, the process proceed to S715.

In S714, as described in S602 and S603 in FIG. 6, the CPU 212 uses the wireless unit 226 to measure the radio field intensities of APs located near the MFP 100, and transmits a list of the radio field intensities of the APs to the currently connected AP as Beacon Report.

In S715, the CPU 212 determines whether a connection destination change request (described above in S605) is received from the currently connected AP. If a connection destination change request is received, the process proceed to S716; otherwise, the process proceed to S719.

In S716, the CPU 212 determines whether the change of the connection destination according to the received connection destination change request is acceptable. If it is determined that the change of the connection destination is acceptable, the process proceeds to S718; otherwise, the process proceeds to S717. One example of the state in which the change of the connection destination is not acceptable (or unacceptable state) is a state in which printing is in progress with print data (print job) being received from another information processing apparatus via the currently connected AP. Another example is, for example, a power-saving state that keeps clocks down relative to clocks used for a process of connecting to an AP.

In S717, the CPU 212 responds to and rejects the connection destination change request received in S715 or ignores the connection destination change request without responding. Then, the CPU 212 performs control not to perform the change of the connection destination AP based on the connection destination change request.

In S718, the CPU 212 responds to the connection destination change request received in S715 and transmits information indicating acceptance of the request to the currently connected AP. Then, the CPU 212 disconnects the connection to the currently connected access point AP1 (101), and executes a process of connecting to an AP recommended for connection included in the connection destination change request received in S715. That is, the CPU 212 changes the connection destination AP in accordance with the connection destination change request. More specifically, the CPU 212 performs the processing described in S606 to S609 in FIG. 6.

In S719, the CPU 212 determines whether the wireless connection with the currently connected AP has been terminated (disconnected). The termination of the wireless connection, which is determined here, occurs in response to, for example, an event of turning off the power to the MFP 100, a setting of disabling the wireless connection, or failure to receive a radio wave from the currently connected AP. In S719, disconnection from the original connection destination due to the processing of changing the connection destination in accordance with the connection destination change request is not to be determined. If the wireless connection with the currently connected AP has not been terminated, the process returns to S713. If the wireless connection with the currently connected AP has been terminated, the process illustrated in FIGS. 7A and 7B ends.

The process illustrated in FIG. 7C will be described. When the mobile terminal device 104 is set to the wireless LAN setup mode, the process illustrated in FIG. 7C is started.

In S731, the CPU 412 establishes a connection with the MFP 100 in the P2P mode.

In S732, the CPU 412 transmits the connection information (such as the SSID and the password) of the AP (in the present embodiment, the access point AP1 (101)) connected immediately before the start of the process illustrated in FIG. 7C to the MFP 100. The transmitted information is received by the MFP 100 in S702 as described above.

In S733, the CPU 412 disconnects the P2P connection with the MFP 100 and establishes an infrastructure connection with the access point AP1 (101).

In S734, the CPU 412 transmits a communication confirmation request to the currently connected AP. The communication confirmation request has been described above in S707. For example, the CPU 412 transmits a reference request (GetRequest-PDU) to the access point AP1 (101) by broadcast by using SNMP.

In S735, the CPU 412 determines whether a communication confirmation response (the response data described above) transmitted from the MFP 100 is received before a predetermined waiting time elapses. If the response is received, the process proceeds to S736. If the response is not receivable even after the predetermined waiting time has elapsed, the process proceeds to S738.

In S736, the CPU 412 determines whether the completion of other setups is confirmed. Examples of the other setups include a setup of application software (hereinafter, simply referred to as an application) in the mobile terminal device 104. The mobile terminal device 104 requests capability information from the MFP 100, and the MFP 100 transmits capability information thereof to the mobile terminal device 104. Accordingly, the information on the MFP 100 is registered in the application in the mobile terminal device 104, and thereafter, communication with the MFP 100 can be performed by the application. Specifically, for example, a print job can be transmitted to the MFP 100 by the application (print driver). If the completion of the other setups is successfully confirmed, the process proceeds to S737. If the other setups fail, the process proceeds to S738.

In S737, the CPU 412 causes the display unit 420 to display information indicating that the wireless LAN setup with the MFP 100 is successful. Then, the process illustrated in FIG. 7C ends.

In S738, the CPU 412 causes the display unit 420 to display information indicating that the wireless LAN setup with the MFP 100 has failed. Then, the process illustrated in FIG. 7C ends.

According to the present embodiment described above, the connection destination change based on a change request is set to be suppressed at the time of the wireless LAN setup. Thus, even if a connection destination change request is received from the AP, the connection destination AP is not changed. Accordingly, during the wireless LAN setup and until the elapse of a predetermined time at which it is assumed that the communication confirmation has been completed, processing can be performed while a connection to a single AP is maintained. Therefore, it is possible to suppress a failure in the wireless LAN setup due to a failure to confirm communication between the mobile terminal device 104 and the MFP 100.

In a case where a connection is made to an AP without using the wireless LAN setup in accordance with connection information input to the MFP 100 by the user, it is not necessary to confirm communication with the mobile terminal device 104. In this case, accordingly, even if the predetermined time has not elapsed since the completion of the connection to the AP (that is, even if the specific condition is not satisfied), the connection destination AP is changed in accordance with a connection destination change request as long as the change request is acceptable.

### Second Embodiment

The first embodiment has described an example in which the connection destination change based on the connection destination change request is suppressed until a predetermined time elapses from when the MFP 100 connects to an AP in the wireless LAN setup mode. A second embodiment describes an example in which the connection destination change based on the connection destination change request is suppressed until, in addition to or instead of the elapse of the predetermined time from when the MFP 100 connects to an AP, a suppression cancellation request indicating the completion of the setup is received from the mobile terminal device 104.

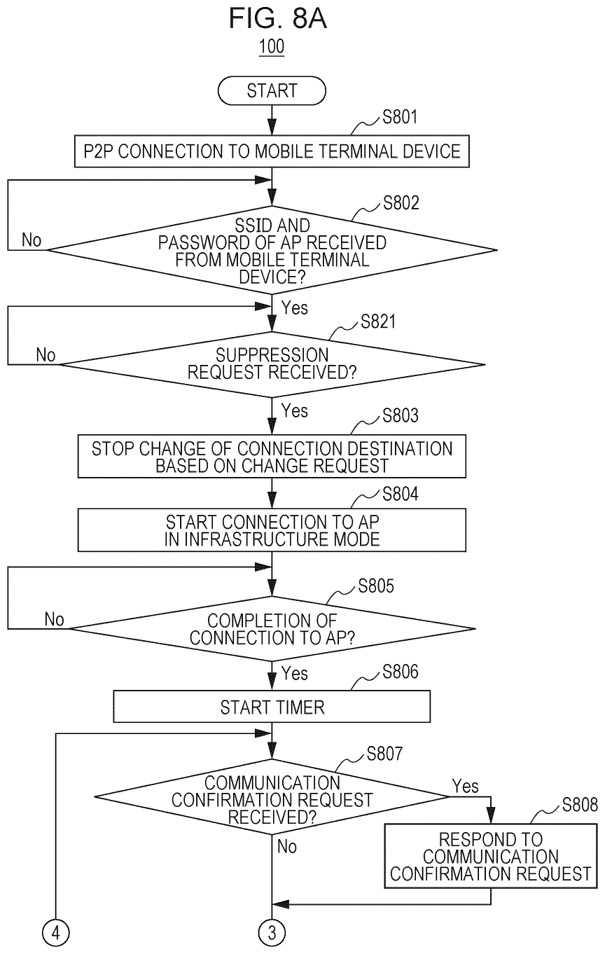

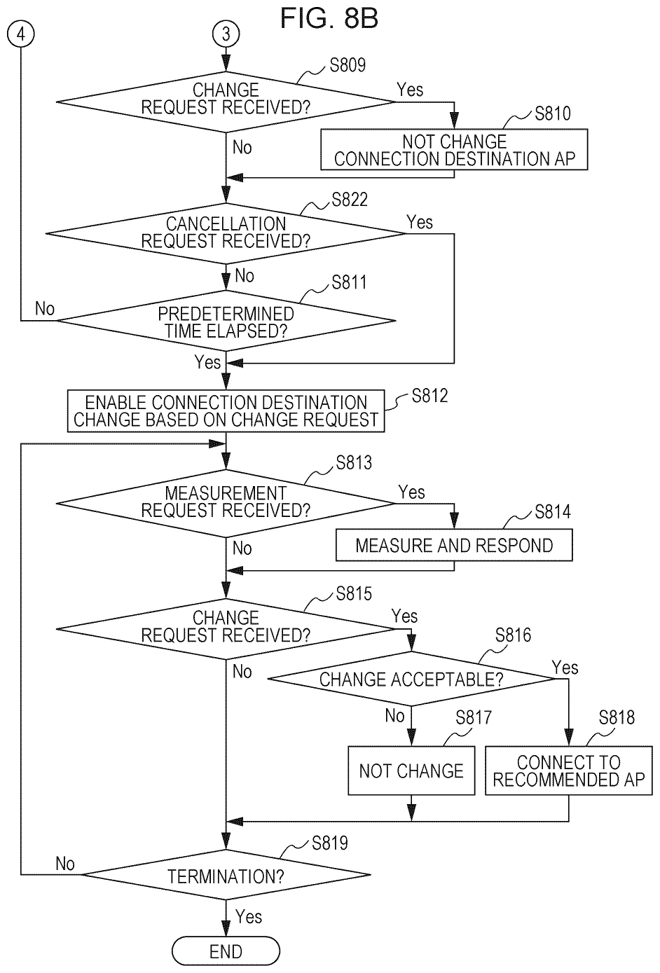

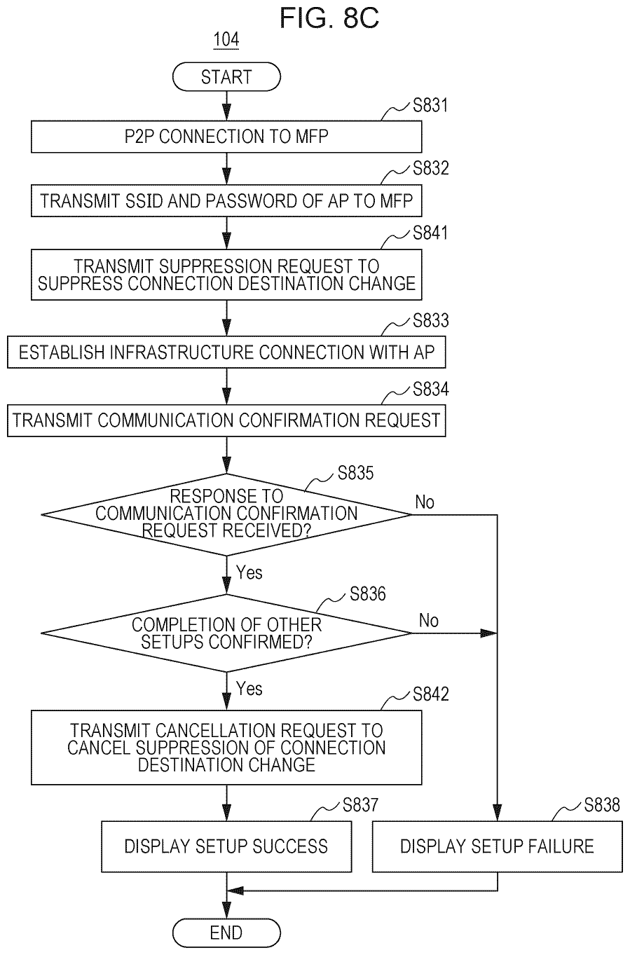

FIGS. 8A and 8B are a flowchart of a wireless LAN setup process executed by the MFP 100 and a subsequent process for changing a connection destination in accordance with a connection destination change request according to the second embodiment. The illustrated process is implemented by the CPU 212 reading a program stored in the ROM 213 into the RAM 214 and executing the program. The illustrated process is different from that illustrated in FIGS. 7A and 7B described above in S821 and S822.

The processing of S801 and S802 is similar to the processing of S701 and S702 in FIG. 7A described above, and a description thereof will be omitted. Note that if Yes is determined in S802, the process proceeds to S821.

In S821, the CPU 212 determines whether a connection destination change suppression request transmitted from the mobile terminal device 104 is received. If the connection destination change suppression request is received, the process proceeds to S803 to set the suppression state; otherwise, the process waits for the connection destination change suppression request to be received. As described above, in the second embodiment, the suppression state is set based on an instruction from the mobile terminal device 104. The suppression state may be set, instead of based on an instruction from the mobile terminal device 104, in response to receipt of connection information from the mobile terminal device 104, as in the first embodiment. That is, the processing of S821 may be omitted.

The processing of S803 to S810 is similar to the processing of S703 to S710 in FIGS. 7A and 7B described above, and a description thereof will be omitted. Note that if No is determined in S809, the process proceeds to S822.

In S822, the CPU 212 determines whether a suppression cancellation request transmitted from the mobile terminal device 104 is received. The suppression cancellation request is a request to cancel the suppression of the connection destination change based on the connection destination change request. If the suppression cancellation request is received, the process proceeds to S812 to cancel the suppression state; otherwise, the process proceeds to S811. As described above, in the second embodiment, the suppression state is canceled based on an instruction from the mobile terminal device 104. This makes it possible to change the connection destination AP in accordance with a connection destination change request without waiting for the elapse of a predetermined time after the mobile terminal device 104 confirms the completion of the wireless LAN setup.

The processing of S811 to S819 is similar to the processing of S711 to S719 in FIG. 7B described above, and a description thereof will be omitted. The processing of S811 may be omitted, and the process may return to S807 if No is determined in S822. As described above, the elapse of the predetermined time is not used as the condition for canceling the suppression state, thereby ensuring that the suppression state can be canceled after the suppression cancellation request transmitted from the mobile terminal device 104 is received. That is, it is possible to change the connection destination AP in accordance with a connection destination change request after the mobile terminal device 104 reliably confirms the completion of the wireless LAN setup.

FIG. 8C is a flowchart of a wireless LAN setup process executed by the mobile terminal device 104 according to the second embodiment. FIG. 8C illustrates a process linked to the process illustrated in FIGS. 8A and 8B, which is executed by the MFP 100. The illustrated process is implemented by the CPU 412 reading a program stored in the ROM 413 into the RAM 414 and executing the program. The illustrated process is implemented by execution of an application or an OS installed in the mobile terminal device 104. The illustrated process is different from that illustrated in FIG. 7C described above in S841 and S842.

The processing of S831 and S832 is similar to the processing of S731 and S732 in FIG. 7C described above, and a description thereof will be omitted.

In S841, the CPU 412 transmits a request for suppressing the connection destination change that is based on a connection destination change request to the MFP 100. The transmitted request is received by the MFP 100 in S821 as described above. The processing of S841 may be omitted, like S821 as described above.

The processing of S833 to S836 is similar to the processing of S733 to S736 in FIG. 7C described above, and a description thereof will be omitted. Note that if Yes is determined in S836, the process proceeds to S842.

In S842, the CPU 412 transmits a suppression cancellation request for canceling the suppression of the connection destination change that is based on a connection destination change request to the MFP 100. The suppression cancellation request can also be information corresponding to enabling (or permitting) the connection destination to be changed in accordance with a request for changing the connection destination AP. The suppression cancellation request can also be information indicating that all the wireless LAN setup processes to be performed by the mobile terminal device 104 for the MFP 100 have been completed. The transmitted request is received by the MFP 100 in S822 as described above.

The processing of S837 and S838 is similar to the processing of S737 and S738 in FIG. 7C described above, and a description thereof will be omitted.

According to the embodiments described above, at the time of the wireless LAN setup, after a connection is made to an AP, the connection destination change based on a change request is set to be suppressed until a specific condition (such as the elapse of a predetermined time or reception of a cancellation request) is satisfied. Thus, even if a connection destination change request is transmitted from the AP, the connection destination AP is not changed. Accordingly, during the wireless LAN setup and until a specific condition is satisfied, processing can be performed while a connection to a single AP (or the same AP) is maintained. This configuration can reduce the possibility that the setup for a wireless LAN for connecting to an AP by transmitting the connection information from the mobile terminal device 104 to the MFP 100, which is an electronic apparatus, fails due to a change of a connection destination AP.

The various types of control described above as being performed by the CPU 212 or 412 may be performed by one piece of hardware, or a plurality of pieces of hardware (e.g., a plurality of processors or circuits) may share processing to control the overall operation of the MFP 100 or the mobile terminal device 104.

While the present disclosure has described, in detail, exemplary embodiments thereof, some embodiments are not limited to these specific embodiments and may be modified in various ways without departing from the scope of the disclosure. Such modifications also fall within the scope of the present disclosure. The embodiments described above are examples, and any combination thereof may be used.

In the embodiments described above, furthermore, the present disclosure is applied to an MFP, by way of example. However, the present disclosure is not limited to the illustrated example, and is applicable to any wireless device that functions as an STA capable of performing a process in accordance with a connection destination change request from an AP. That is, the present disclosure is applicable to a PC, a PDA, a tablet terminal, a mobile phone terminal such as a smartphone, a music player, a game device, an electronic book reader, a smart watch, and various measurement devices (sensor devices) such as a thermometer and a hygrometer. The present disclosure is also applicable to digital cameras (including a still camera, a video camera, a network camera, and a security camera), a printer, a scanner, and a drone. The present disclosure is also applicable to a video output device, an audio output device (e.g., a smart speaker), a media streaming player, and a wireless LAN slave device (adapter) connectable to a Universal Serial Bus (USB) terminal or a LAN cable terminal. The video output device includes, for example, a device, such as a set-top box, and is configured to acquire (download) a moving image or a still image from the Internet, which is identified by a uniform resource locator (URL) specified by an electronic apparatus, and output the moving image or the still image to a display device connected via a video output terminal, such as a High-Definition Multimedia Interface (HDMI®) video output terminal. This configuration implements streaming playback on the display device and implements mirroring display (display that allows content displayed on the electronic apparatus to also be displayed on the display device). In addition, the video output device includes media players, such as a hard disk recorder, a Blu-ray recorder, and a DVD recorder, a head mounted display, a projector, a television, a display device (monitor), and a signage device, for example. The present disclosure is also applicable to Wi-Fi-enabled devices called smart home appliances, such as a smart air conditioner, a smart refrigerator, a smart washing machine, a smart vacuum cleaner, a smart oven, a smart microwave oven, a smart lighting system, a smart heater, and a smart cooler.

According to embodiments of the present disclosure, it is possible to reduce the possibility that the setup for a wireless LAN for connecting an electronic apparatus to an AP by transmitting connection information from a terminal device to the electronic apparatus fails due to a change of a connection destination AP.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-107825, which was filed on Jun. 30, 2023 and which is hereby incorporated by reference herein in its entirety.

What is claimed is:

1. An electronic apparatus comprising:
at least one memory and at least one processor that are configured to:
receive a change request from a currently connected access point (AP) to change a connection destination AP to connect to;
acquire, from a terminal device, connection information for connecting to a specific AP;
perform a process of connecting to the specific AP in accordance with the connection information;
perform control to execute a connection destination change based on the change request to change the connection destination AP in a first state in which a specific condition is satisfied after a connection is made to the specific AP; and
perform control not to execute the connection destination change based on the change request in a second state in which the specific condition is not satisfied after a connection is made to the specific AP.

2. The electronic apparatus according to claim 1, wherein
the specific condition includes a condition that a predetermined time has elapsed since the connection was made to the specific AP.

3. The electronic apparatus according to claim 1, wherein
the specific condition includes a condition that specific information is received from the terminal device after the connection is made to the specific AP.

4. The electronic apparatus according to claim 3, wherein
the specific information is information corresponding to permission for the connection destination change based on the change request.

5. The electronic apparatus according to claim 3, wherein
the specific information is information indicating that a wireless local area network (LAN) setup process to be performed by the terminal device for the electronic apparatus has been completed.

6. The electronic apparatus according to claim 1, wherein
the at least one memory and the at least one processor are configured to acquire the connection information when the electronic apparatus is being connected to the terminal device without intervention of an AP.

7. The electronic apparatus according to claim 1, wherein
the at least one memory and the at least one processor are configured to acquire the connection information in a wireless LAN setup process of the electronic apparatus.

8. The electronic apparatus according to claim 1, wherein
the at least one memory and the at least one processor are configured to, when connecting to the specific AP in accordance with the connection information, control to set a suppression state in which the connection destination change based on the change request is suppressed.

9. The electronic apparatus according to claim 8, wherein
in a case where the suppression state is set,
the at least one memory and the at least one processor are configured to perform control to transmit information to the specific AP and connect to the specific AP, the information indicating that a function for the connection destination change based on the change request is not supported by the electronic apparatus.

10. The electronic apparatus according to claim 8, wherein
in a case where the suppression state is set,
the at least one memory and the at least one processor are configured to perform control to respond to a measurement request received from the currently connected AP by transmitting information indicating a worse radio wave condition than a condition measured for an AP other than the currently connected AP or perform control not to execute the connection destination change based on the change request even if the change request is received from the currently connected AP.

11. The electronic apparatus according to claim 1, wherein
in the first state,
the at least one memory and the at least one processor are configured to perform control not to execute the connection destination change based on the change request in a state in which the change request is not acceptable.

12. The electronic apparatus according to claim 11, wherein
the state in which the change request is not acceptable is at least one of a power-saving state and a state in which printing is in progress with print data being received via the currently connected AP.

13. The electronic apparatus according to claim 1, wherein
the at least one memory and the at least one processor are configured to perform control to execute the connection destination change based on the change request, after a connection is made to an AP in accordance with connection information input from a user, even if the specific condition is not satisfied.

14. The electronic apparatus according to claim 1, wherein
the at least one memory and the at least one processor are further configured to:
perform control to execute printing on a print sheet.

15. The electronic apparatus according to claim 1, wherein
the electronic apparatus performs IEEE 802.11ax connection to an AP and performs a process compliant with an IEEE 802.11ax standard.

16. The electronic apparatus according to claim 1, wherein
the electronic apparatus performs at least one of a process compliant with Orthogonal Frequency Division Multiple Access (OFDMA) and a process compliant with Target Wake Time (TWT).

17. The electronic apparatus according to claim 1, wherein
the connection destination change based on the change request is performed to change the connection destination AP to an AP using a 6 GHz frequency band.

18. A method for controlling an electronic apparatus, the method comprising:
receiving a change request from a currently connected access point (AP) to change a connection destination AP to connect to;
acquiring, from a terminal device, connection information for connecting to a specific AP;
performing a process of connecting to the specific AP in accordance with the connection information;
performing control to execute a connection destination change based on the change request to change the connection destination AP in a first state in which a specific condition is satisfied after a connection is made to the specific AP; and
performing control not to execute the connection destination change based on the change request in a second state in which the specific condition is not satisfied after a connection is made to the specific AP.

19. A non-transitory computer-readable storage medium storing computer-executable instructions that, when executed by one or more computers, cause the one or more computers to:
receive a change request from a currently connected access point (AP) to change a connection destination AP to connect to;
acquire, from a terminal device, connection information for connecting to a specific AP;
perform a process of connecting to the specific AP in accordance with the connection information;
perform control to execute a connection destination change based on the change request to change the connection destination AP in a first state in which a specific condition is satisfied after a connection is made to the specific AP; and
perform control not to execute the connection destination change based on the change request in a second state in which the specific condition is not satisfied after a connection is made to the specific AP.
